(19) United States
(12) Patent Application Publication
(10) Pub. No.: US 2005/0109951 A1
(43) Pub. Date: May 26, 2005

(54) Novel device, system and method for fluorescence detection

(76) Inventors: Falk Fish, Tel Aviv (IL); Zvi Greenberg, Rehovot (IL); Ouriel Faktor, Rehovot (IL)

Correspondence Address: FOLEY HOAG, LLP;PATENT GROUP, WORLD TRADE CENTER WEST, 155 SEAPORT BLVD, BOSTON, MA, 02110, US

(21) Appl. No.: 10/500,186

(22) PCT Filed: Dec. 26, 2002
(86) PCT No.: PCT/IL02/01040

Related U.S. Application Data
(60) Provisional application No. 60/342,392, filed on Dec. 27, 2001.

(51) Int. Cl. G01N 21/64

(52) U.S. Cl. 250/461.1

(57) ABSTRACT

A device, system and method for portable fluorescence detection. The portable device of the present invention features a low power light, in which a wavelength range is defined as at least one wavelength of light. The light source is preferably highly energy efficient, such that a majority of the electrical power which is consumed is then converted into transmitted light. The emitted light from the excited fluorophore is then preferably detected with any low cost and low power photodetector. Although optionally a highly sensitive optical detector may be used, preferably fluorescence is detected with any light sensing device, such as a regular photodiode or a CCD (charge-coupled device) sensor for example.

### FIELD OF THE INVENTION

The present invention relates to a novel device, system and method for fluorescence detection, and in particular, to fluorescence detection with an inexpensive, portable device.

### BACKGROUND OF THE INVENTION

Fluorescence is used as a marker for various biological, medical and diagnostic assays. In order to be able to detect fluorescence, and hence to be able to use it as a marker for these assays, a number of components are required. First, a suitable fluorophore must be selected. The fluorophore should be excitable at a wavelength which is suitable for the given application, with a strong signal (emission of light). In addition, the fluorophore should be resistant to photobleaching, for maximum efficiency of detection.

The fluorophore is then excited by the application of light of the appropriate wavelength. For excitation of the fluorescent material, a very strong light source, such as a LASER, xenon- or mercury-arc lamps or high-powered tungsten-halogen bulb (see Table 1 of the appendix section for a complete list of conventional light sources.). For a white light source, such as xenon or halogen, the light has to be accurately filtered to permit only a very narrow bandwidth of wavelengths to pass for excitation of the fluorophore.

In addition, fluorescence detection requires a very sensitive light detection or sensing device, such as a photomultiplier (PMT) tube, avalanche photodiodes or a CCD video camera, in which the CCD element is cooled to reduce electronic noise so that long exposure times can be used to detect the low amount of light emanating from the above fluorescent materials. The light entering the detection device has to be accurately filtered, to fit the fluorescent emission of the fluorophore.

The electronic components which are required for fluorescence detection are currently expensive and large or heavy, consume a significant amount of energy and may require active cooling and complicated control circuits. FIG. 3 shows a table of a number of exemplary fluorescent light sources, which are typical of the background art, as they are complex, expensive and/or heavy.

One example of a background art system is disclosed in U.S. Pat. No. 6,287,871, in which a laser light source is employed for excitation in order to view reaction lines on a lateral flow immunochromatography device. The disclosed system includes an optical detection system, in which a collection lens focuses light to a detector, such as a CCD (charge-coupled device) camera or a photomultiplier. Each of these components is both expensive and awkward to handle, due to size, weight, sensitivity to movement or a combination. In particular, the disclosed system may be suitable for a stationary fluorescence detection system, but is not suitable for a portable device for fluorescence detection.

Inexpensive, small (“pocket-sized”), portable devices for fluorescence detection would be highly useful in a variety of applications. For example, such devices would be quite useful in the field of medical diagnostics, in which fluorescence based methods could provide sensitive and accurate tests in non-laboratory environments. Non-limiting examples of such environments include the emergency room, the bedside of the patient at home or in the hospital, physician's office, ambulance, battlefields and other treatment areas which may lack ready access to laboratory equipment and assays.

### SUMMARY OF THE INVENTION

The background art does not teach or suggest a device, system or method for providing portable fluorescence detection. The background art also does not teach or suggest a highly portable, inexpensive yet robust and sensitive device for fluorescence detection.

The present invention overcomes these deficiencies of the background art by providing a device, system and method for portable fluorescence detection. The portable device of the present invention features a low power light source, preferably of a defined wavelength range. By “defined wavelength range”, it is meant that the difference between the minimum and maximum wavelengths included in the range is preferably restricted to those that are close to the excitation (=absorption) maximum of the fluorescent reporter material but are lower than the emission (=fluorescence) maximum of the reporter material. Optionally and preferably, the term “defined wavelength range” may also encompass light emitted from light sources such as lasers, that emit light of a single wavelength. By “low power” it is meant that the power consumption does not exceed about 500 mW, is preferably less than about 200 mW and is more preferably less than about 120 mW.

The emitted light is then preferably detected with any suitable photodetector. Although optionally a highly sensitive optical detector may be used, preferably fluorescence is detected with any regular photodiode, photocell, photoresistor, phototransistor or noncooled CCD (charge-coupled device) sensor.

The method according to the present invention may optionally be implemented with any device and/or system according to the present invention. One exemplary method preferably includes, in a first stage, providing a portable device for detection of fluorescence in a sample containing a fluorophore, the portable device comprising: a light source for emitting light for exciting the fluorophore, wherein the light is of a defined wavelength range; and a photodetector for detecting emitted light from the excited fluorophore. In stage 2, the sample is preferably entered to the portable device. In stage 3, the light source emits light, thereby exciting the fluorophore. In stage 4, the photodetector detects light emitted from the excited fluorophore. Optionally, in stage 5, one or more computations are performed on a signal obtained from the photodetector. Also optionally, in stage 6, the results of the computations are displayed and/or otherwise provided.

The present invention is preferably suitable for the detection and/or viewing of deposits of fluorophores on flat surfaces, such as the surface of lateral flow immunochromatography devices, by employing low-cost and low-power devices.

The device of the present invention is preferably characterized by being an inexpensive, small (“pocket-sized” or hand-held), portable device for fluorescence detection, which may optionally be powered by a battery.

### BRIEF DESCRIPTION OF THE DRAWINGS

The invention is herein described, by way of example only, with reference to the accompanying drawings, wherein:

FIG. 1 is a schematic block diagram of a device according to the present invention;

FIG. 2 shows an image of actual test results for detection of a fluorescent signal on a lateral flow test strip; and

FIG. 3 shows a table of exemplary fluorescence excitation sources.

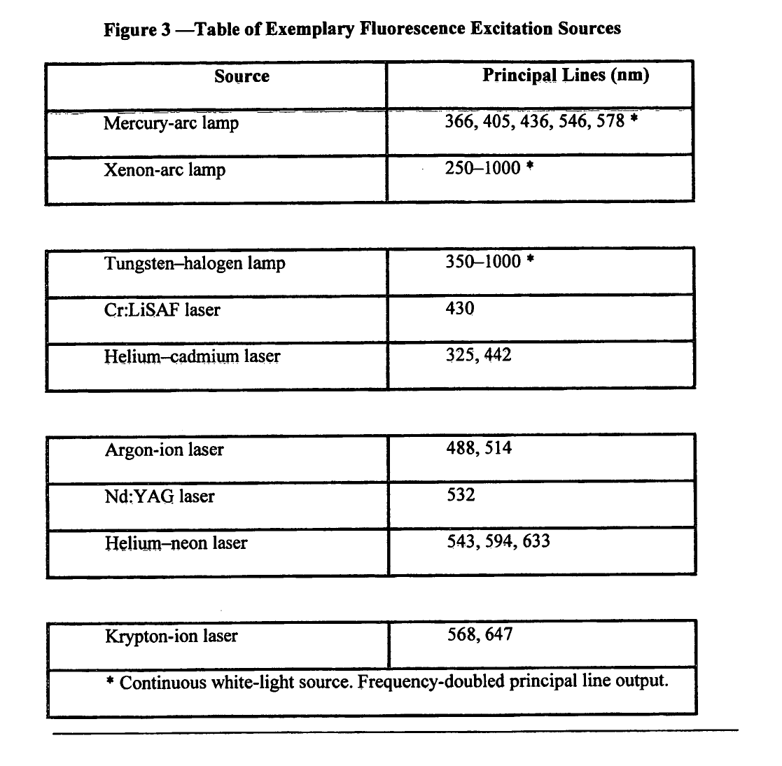

### DESCRIPTION OF THE PREFERRED EMBODIMENTS

The present invention is of a device, system and method for portable fluorescence detection. The portable device of the present invention features a light source of a defined wavelength range, in which a wavelength range is defined as at least one wavelength of light. The light source is preferably a low power light source, such that the light source has low power consumption. Low power consumption preferably enables the light source to be operable from a small battery. The light source is also preferably energy efficient, such that a majority of the electrical power which is consumed is then converted into transmitted light.

The emitted light from the excited fluorophore is preferably filtered to remove the upper wavelengths that correspond to the wavelength of the fluorescence emission. The fluorescence emission is then preferably filtered and detected with any suitable photodetector. Although optionally a highly sensitive optical detector may be used, fluorescence is preferably capable of being detected with any regular photodiode, photocell, photoresistor, phototransistor or a low-cost CCD (charge-coupled device) sensor in order to simplify the system and reduce its cost.

A preferred example of a low power light source of a defined wavelength range is a LED (light emitting diode), operated at low voltage. For the preferred example described herein, the light source is the Nichia Green LED, providing 10 CD at a current of 20 mA and voltage drop of from about 2 to about 3.5 V. However, substantially any suitable LED may optionally be used. For example, optionally an OLED (organic light emitting diode) may be used as a light source for the present invention. Furthermore, substantially any type of light source being characterized by being at least one of low power and/or low cost may optionally be used.

Optionally and more preferably, the LED is characterized by having a luminous intensity from about 1mCD to about 10 CD. Most preferably, the luminous intensity is from about 10 mCD to about 1 CD. The LED, or any other light source that is used in addition to, or in place of, the LED for the present invention, is optionally implemented as a plurality of light sources, and optionally and more preferably, as an array of light sources.

The LED optionally and preferably emits a colored light. By “colored light”, it is meant light having one or more wavelengths that are dominant, in terms of luminous intensity, as compared to the remaining one or more wavelengths present in the light, if any. For a laser light source, for example, typically the emitted light has only one wavelength, such that the light would have a color according to that single wavelength. Other light sources typically emit light of a plurality of wavelengths. If the emitted light does not have one or more dominant wavelengths, then the resultant light appears to be white rather than colored, as for a regular incandescent light bulb, for example. Such white light is not considered to be colored light within the present invention.

For the present invention, optionally and more preferably, the colored light has a color selected from the group consisting of ultraviolet, white, blue, green, yellow-green, yellow, orange, red, and infra-red. It should be noted that for the present invention, the wavelength(s) of the emitted light is not limited to the visible spectrum. It also should be noted that even for light sources emitting non-colored light, the emitted light may also optionally be colored, for example by treating the light source and/or adding a material to the light source, and/or by filtering the emitted light to form colored light.

Optionally and more preferably, the transmitted light from the light source is filtered, more preferably with a wide bandwidth excitation filter. Most preferably, the filter is a low cost gelatin filter. The filter may optionally be used with any type of light source, such as a light source for producing colored light and/or a light source for producing white light. In any case, the filter is preferably selected according to the desired wavelength of light being transmitted, such as for example according to the preferred wavelength or wavelengths at which excitation of the fluorescent material or fluorophore occurs. For the preferred example described herein, the filter is most preferably a Minus-Red Wratten 44A gelatin filter.

The photodetector is preferably of low cost and/or of low sensitivity. Optionally and more preferably, the photodetector may optionally include one or more of any regular photodiode, a photocell, a phototransistor, a noncooled CCD (charge-coupled device), photoresistor, a sensor photodiode, or an array thereof. More preferably, the photodetector includes a photodiode. Alternatively and more preferably, the photodetector includes a CCD. The photodetector preferably has an exposure time in a range of from about 1/100 seconds to about 60 seconds. Most preferably, this exposure time is in a range of from about 1/70 seconds to about 1/10 seconds.

A preferred example of a photodetector is a low cost CCD sensor, such as the Texas Instruments I TC255, operated at 6-bit grayscale color depth. Optionally and more preferably, the emitted light from the fluorophore, which constitutes the fluorescence signal, is filtered with a suitable filter, such that the filter is able to block the excitation wavelengths. For the preferred example described herein, the emitted light is filtered with an IR filter and 590 nm Long Pass filter. Exposure is optionally in a range of from about 1/100 seconds to about 1 second, and more preferably in a range of from about 1/70 seconds to about 1/10 seconds. In the examples described in greater detail below, exposure was found to be sufficient in a range of from about 1/60 to about 1/30 seconds. In case higher sensitivity is required and a CCD is employed as the sensing element, exposure time can be increased to the seconds time range.

Optionally and preferably, the fluorophore which is used with the device according to the present invention is a high efficiency fluorophore, which is resistant to photobleaching. More preferably, the fluorophore emits light toward or in a near red and infra-red range (about 600 nm and above), which is the most efficient range of wavelengths for detection by CCD and photodiode sensors, and also for generation of light by LEDs. Preferably, the device includes a filter for filtering emitted light from the excited fluorophore. The filter is preferably selected according to a wavelength or wavelengths of emitted light from the excited fluorophore. One preferred but non-limiting example of such a fluorophore is Alexa 594, available from Molecular Probes, Inc., Eugene, Oreg. 97402-9165, USA. Preferably, the emitted light from the excited fluorophore is filtered with a 590 nm Long Pass filter for this non-limiting example.

The preferred but exemplary combination of excitation and detection devices, described above, was successfully employed with Alexa 594 labeled streptavidin (Molecular Probes, Inc., USA) in the detection of per-sero-conversion HIV positive specimens within 5 minutes of incubation. Such specimens have previously required a high sensitivity ELISA with 4 hours of incubation time. The device of the present invention was able to detect such positive specimens within minutes, in a highly accurate, sensitive manner.

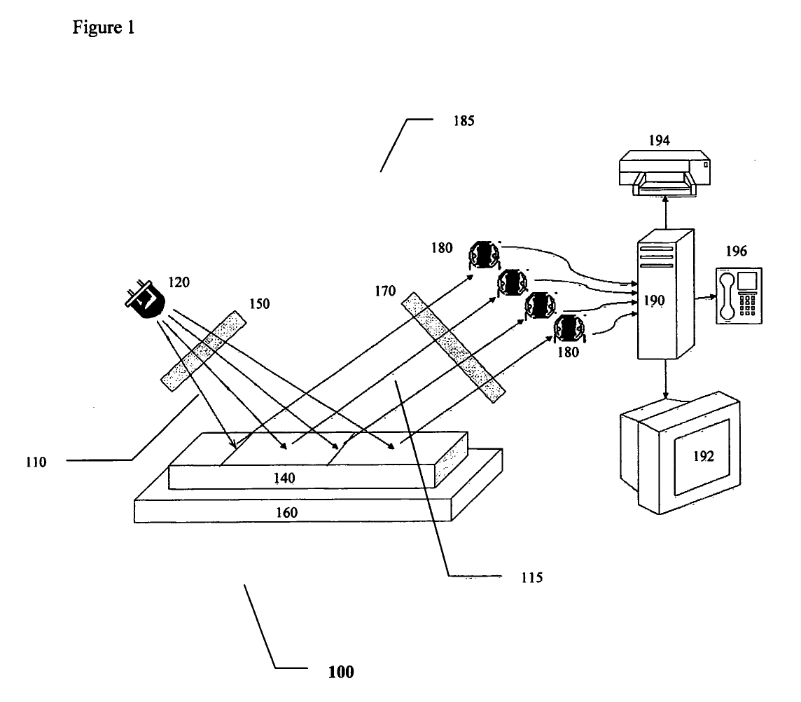

Referring now to the drawings, FIG. 1 is a schematic block diagram of an exemplary device according to the present invention. As shown, a device 100 features a light source 120, preferably of a defined wavelength range, in which a wavelength range is defined as at least one wavelength of light. Light source 120 preferably has low power. Light source 120 is also preferably highly energy efficient, such that a majority of the electrical power which is consumed is then converted into transmitted light. Light 110 emitted from light source 120 is preferably transmitted through a filter 150 to a sample 140, optionally contained in, and/or presented on, a sample holder 160. Sample 140 features at least one fluorophore, which becomes excited by light 110 from light source 120.

The excited fluorophore then emits emitted light 115. Emitted light 115 from the excited fluorophore is preferably filtered through an emission filter 170, and is preferably detected with a single photodetector 180 or an array thereof (not shown). Preferably, photodetector 180 includes any one or more of any regular photodiode, photoresistor, phototransistor, photocells or CCD (charge-coupled device) sensor (preferably a non-cooled CCD), or an array thereof, as described previously.

Photodetector 180 is optionally and preferably connected to a computational device 190 for analyzing the received signal. Computational device 190 may optionally be any type of device that is capable of performing the necessary computations, including but not limited to, a computer, a portable computer, a hand-held computer, a Personal Digital Assistant (PDA), a cellular telephone, or wearable computer, a paging device, or any other suitable device and is optionally a microprocessor-based circuit or device.

The results of the computation can then optionally be displayed on a suitable display device 192, and/or printed through a printer 194, and/or transmitted to a remote location through a connector to a wired 196 or wireless network, wherein a network may optionally include a telephonic system. The results may also optionally be stored, transmitted, displayed and/or manipulated as desired.

A system 185 may optionally and preferably include a combination of device 100 according to the present invention and computational device 190 and/or any peripheral device, including but not limited to, display device 192, and/or printer 194, and/or wired 196 or wireless network. The term “combination” includes but is not limited to, any one or more of in communication with, connected to and/or housed with. System 185 may also optionally, additionally or alternatively, include a lateral flow immunochromatography device for holding the sample and optionally one or more reagents.

### EXAMPLES

### Example 1

### Imaging of Fluorescence Employing a LED Source and Simple CCD Camera

The device according to the present invention is preferably capable of detecting, imaging, capturing or otherwise sensing a fluorescent signal that is emitted from an excited fluorophore. As described above, the device is preferably capable of performing this task with a low cost and/or low power light source, and a low cost and/or low sensitivity photodetector. Non-limiting examples of such a light source and a photodetector is a LED and a non-cooled CCD camera, respectively. This Example describes the capture of an image of test results obtained with these non-limiting examples, with a sample containing a fluorophore.

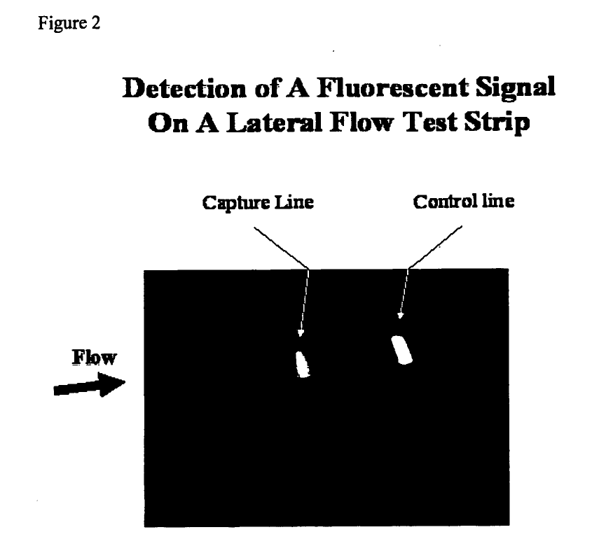

FIG. 2 shows an image of actual test results for detection of a fluorescent signal on a lateral flow test strip. As shown, both a capture line 200 and a control line 210 give strong signals, with low to minimal background. The direction of flow is indicated by the arrow labeled “flow”.

The following was performed for obtaining the image of FIG. 2. To prepare the nitrocellulose strips, High Flow plus (HF 18004) nitrocellulose membrane rolls 25 mm wide were obtained from Millipore, Bedford, Ma., USA. They were cut to sheets and used “as is” for dispensing of capture line.

Next, the HIV antigen capture line mix was prepared as follows. The following HIV derived recombinant proteins were diluted into a solution of 0.02M carbonate buffer, pH 9.6, 2% sugar (glucose) and 0.25M Urea: Dev-1 recombinant gp41 and C-terminus of gp 120 in Urea buffer obtained from Cytolab, Rehovoth, Israel; Env-1 recombinant gp41 and gp120, Diaproph, Kiev, Ukraine; Recombinant Gag-120, Diaproph, Kiev, Ukraine; and Recombinant gp 36, Standard Diagnostics, Inc.,Kyonggi-do, S Korea.

The mixture was mixed thoroughly for 15 minutes immediately before being sprayed on the nitrocellulose sheet, employing a BioDot robotic XYZ dispensing instrument equipped with a BioJet dispense head. The mixture was dispensed at a rate of 1.0 μL/cm.

Next, Protein A mix for the control line was prepared as follows. Lyophilized Protein A (Zymed, South San Francisco, Calif., USA) was dissolved to a final concentration of 250 μg/mL in Phosphate Buffered Saline pH 7.5, containing 0.1% w/v sodium azide and was used after a 10-minute mixing. It was sprayed on the nitrocellulose sheets as detailed above, at a distance of 7 mm from the HIV antigen capture line as described above. The nitrocellulose strips were then incubated at 60° C. for 15 minutes and dry stored at 15% humidity.

Next, the conjugate pad was prepared as follows. The conjugate pad (polyester 10.3 mm, grade 2033) was pre-treated with sodium phosphate buffer, containing 0.5% BSA, 0.1% Triton-X-100, and 0.5% polyvinyl alcohol (PVA). Strips were immersed in the buffer solution for 2 hours, and then were blotted on a Whatman filter paper to remove fluid excess, and dried overnight at room temperature.

The above antigen dispensed sheets were fitted with an absorbent pad (GB 003 Gel Blotting Paper from Schleicher & Schuell), sample pad (2002 from Schleicher & Schuell) and conjugate pad (see above) as described in the standard literature (Carlberg, D. L. “Lateral Flow Assays: Designing for Automation”, IVD Technology Magazine, May 99 http://www.devicelink.com/ivdt/archive/99/05/001.html, “A Short Guide—Developing Immunochromatographic Test Strips”, Millipore Corp., 1996, Bedford, Ma., USA, Weiss, A., “Concurrent engineering for lateral-flow diagnostics”, IVD Technology 5, No. 7 (1999): 48-57, http://www.devicelink.com/ivdt/archive/99/11/009.html) and cut into 4 mm wide strips.

The final preparation of Antigen Loaded HIV Antibody Test Strips was performed as follows. Protein A tagged with Alexa 594 fluorophore (Molecular Probes, Inc., Eugene, Oreg., USA) was diluted to a final concentration of 83 μg/mL in 0.1M phosphate buffer pH 7.2 containing sugar. Fifteen μL of this protein A solution was dispensed onto the conjugate pad of each of the strips obtained in Example 5 and dried at 37° C. for 2 hours.

The nitrocellulose portion of each test strip was blocked with 20 μL of Phosphate Buffered Saline with detergent and then dried at 37° C. for 2 hours.

Serum specimens were tested for HIV antibody with the test strips as follows. Serum samples were diluted 1:40 in Phosphate Buffered Saline with non-ionic detergent, and a volume of 100 μL was loaded on the sample pad of the test strip and incubated for 10 minutes at room temperature The fluorescence pattern was recorded with the following components.

Excitation Light Source: 6 Nichia Green LEDs (500 mCD each at 20 mA, 3.5V for each light source)

Excitation Filter: Minus-Red Wratten 44A Filter

Emission Detection Camera: unfocused Connectix QuickCam, a 6-bit grayscale Web-Camera (containing the TI TC255 CCD sensor) fitted with a 30 mm diameter, 50 mm focal length piano-convex lens (K32-484, Edmund Industrial Optics, Barrington, N.J., USA) for close up optical correction and a 590 nm Long Pass filter (51311, Oriel Corp., Stratford, Conn., USA).

### Example 2

### Comparison Between Positive and Negative HIV Specimens

The device according to the present invention was further tested in this Example, to determine whether it could distinguish between positive and negative HIV specimens.

A fluorescence test system was constructed from 5 surface mounted yellow LEDs, which served as the excitation light source, and 5 photodiodes for detecting the emitted fluorescence. A red glass filter was installed in front of the photodiodes to block excitation light. The photodiodes were connected to a phase sensitive detector circuit, which translates the amount of light to counts.

HIV-1 gp41 and HIV-2 gp36 recombinant antigens were diluted in buffer and applied in a 1 mm wide line on the surface of a nitrocellulose membrane. The membrane was then cut into 5 mm wide strips, so that the antigen line traversed the strip. The strips were equipped with specimen and absorbent pads (ImmunoGold™, Orgenics LTD, Yavne, Israel) These completed strips are non-limiting examples of lateral flow immunochromatography devices for use with the present invention.

Another aliquot of the above antigens was conjugated with Alexa 594 fluorophore (Molecular Probes, Eugene, Oreg., USA), employing the Alexa Fluor® 594 Protein Labeling Kit (Molecular Probes) and following the instructions of the kit. The final Moles dye/Moles protein ratio was in a range of from about 4 to about 6 and the final antigen concentration was about 2 mg protein/mL conjugate solution.

HIV-1 positive plasma specimens were obtained from the Kaplan Medical Center, Rehovoth, Israel. HIV-1 Seroconversion specimens were obtained from Serologicals Corp. (Norcross, Ga., USA). Negative specimens were obtained from Intergen/Serologicals Corp.

Each specimen was diluted 1:100 into Tris Buffered Saline with Tween-20 detergent. The fluorophore conjugated antigen mix was then added in a final dilution of 1:50. Eighty microliters of this mixture were applied on the sample pad of the above strips. The fluorescence from the antigen line of the strip was determined 30 minutes later.

The fluorescence reader was set to display 1000 counts for a blank strip and the maximal possible fluorescence reading was 13000.

Ten HIV-1 positive specimens, including seroconversion specimens, yielded fluorescence emission readings ranging from 5220 to 9800 counts. Seven HIV-1 negative specimens yielded readings ranging from 3108 to 4925 counts. These results clearly show that an exemplary device according to the present invention was able to distinguish between HIV-1 positive and HIV-1 negative specimens. Hence, the invention provides fluorescence based method and device for a sensitive detection of antibodies employing low cost and low power light emitting and light detection components.

It will be appreciated that the above descriptions are intended only to serve as examples, and that many other embodiments are possible within the spirit and the scope of the present invention.

1. A portable device for detection of fluorescence in a sample containing a fluorophore, comprising:
(a) a light source for emitting light for exciting the fluorophore, wherein said light is of a defined wavelength range; and
(b) a photodetector for detecting emitted light from the excited fluorophore.

2. The device of claim 1, wherein said light source is characterized by being at least one of a low power or a low cost.

3. The device of claim 2, wherein said light source comprises a low power light source having a power consumption not greater than about 500 mW.

4. The device of claim 3, wherein said power consumption is less than about 200 mW.

5. The device of claim 4, wherein said power consumption is less than about 120 mW.

6. The device of claim 1, wherein said light source comprises a LED (light emitting diode).

7. The device of claim 6, wherein said light source comprises a LED having a luminous intensity from about 1 mCD to about 10 CD.

8. The device of claim 7, wherein said luminous intensity is from about 10 mCD to about 1 CD.

9. The device of claim 1, wherein said light source emits a colored light.

10. The device of claim 1, wherein said light source emits at least one of UV (ultraviolet) light or infra-red light.

11. The device of claim 1, wherein said light source emits a colored light through an alteration and/or an addition to said light source.

12. The device of claim 1, wherein said light source emits a colored light, the device further comprising a filter for filtering light emitted from said light source, wherein said colored light is formed through said filtering.

13. The device of claim 12, wherein said filter comprises a wide bandwidth excitation filter.

14. The device of claim 12, wherein said filter comprises a gelatin filter.

15. The device of any of claim 1, wherein said light source emits a colored light, and said colored light comprises at least one of light having a wavelength in the visible spectrum and light having a wavelength outside the visible spectrum.

16. The device of claim 1, wherein said light source emits a colored light, and said colored light is selected from the group consisting of ultraviolet, white, blue, green, yellow-green, yellow, orange, red, and infra-red.

17. The device of any of claim 1, further comprising a filter for filtering said emitted light from said light source.

18. The device of claim 17, wherein said filter is selected according to said defined wavelength range.

19. The device of claim 17, wherein said filter is selected according to a preferred wavelength or wavelengths for exciting the fluorophore.

20. The device of claim 1, further comprising a plurality of light sources.

21. The device of claim 20, wherein said plurality of light sources is arranged in an array.

22. The device of claim 1, wherein said photodetector is of low cost and/or of low sensitivity.

23. The device of claim 1, wherein said photodetector includes one or more of any regular photodiode, a photocell, a phototransistor, a noncooled CCD (charge-coupled device), a photoresistor, a sensor photodiode, or an array thereof.

24. The device of claim 23, wherein said photodetector comprises a photodiode.

25. The device of claim 23, wherein said photodetector comprises a CCD.

26. The device of claim 1, wherein an exposure time of said photodetector is in a range of from about 1/100 seconds to about 60 seconds.

27. The device of claim 26, wherein said exposure time is in a range of from about 1/70 seconds to about 1/10 seconds.

28. The device of claim 1, wherein the fluorophore emits light in a near red or infrared range.

29. The device of claim 1, further comprising a filter for filtering emitted light from the excited fluorophore.

30. The device of claim 29, wherein said filter is selected according to a wavelength or wavelengths of said emitted light from the excited fluorophore.

31. The device of claim 29, wherein the fluorophore emits light in a near red or infrared range, and said emitted light from the excited fluorophore is filtered with a 590 nm Long Pass filter.

32. A system for detection of fluorescence in a sample containing a fluorophore, comprising:
(a) a portable device according to claim 1; and
(b) a computational device for performing a computation.

33. The system of claim 32, further comprising:
(a) a peripheral device.

34. The system of claim 33, wherein said peripheral device comprises any one or more of a display device, a printer, or a connector to a wired or wireless network, or a combination thereof.

35. The system of claim 32, further comprising a lateral flow immunochromatography device for holding the sample and optionally one or more reagents.

36. A method for detecting fluorescence in a sample containing a fluorophore, comprising:
providing a portable device according to claim 1;
entering the sample is preferably entered to said portable device;
emitting light by a light source of said portable device, thereby exciting the fluorophore; and
detecting light emitted from the excited fluorophore by a photodetector.

37. The method of claim 36, further comprising:
providing a a computational device for performing a computation.

38. The method of claim 37, further comprising:
performing one or more computations on a signal obtained from said photodetector.

39. The method of claim 38, further comprising:
displaying a result of said one or more computations.
